(19) United States
(12) Patent Application Publication
(10) Pub. No.: US 2018/0013831 A1
(43) Pub. Date: Jan. 11, 2018

(54) ALERTING ONE OR MORE SERVICE PROVIDERS BASED ON ANALYSIS OF SENSOR DATA

(71) Applicant: HCL Technologies Limited, Noida (IN)

(72) Inventors: Sourav DEY, Bangalore (IN); Jayaramakrishnan SUNDARARAJ, Bangalore (IN); Senthilkumar VINAYAGAM, Chennai (IN)

(21) Appl. No.: 15/627,297

(22) Filed: Jun. 19, 2017

(30) Foreign Application Priority Data
Jul. 11, 2016 (IN) 201611023628

(51) Int. Cl. H04L 29/08; G08B 25/08; G08B 21/18; G08B 25/00; G08B 31/00; G08B 29/18

(52) U.S. Cl. CPC H04L 67/12; G08B 31/00; G08B 29/186; G08B 21/182; G08B 25/006; G08B 25/08

(57) ABSTRACT

The present disclosure relates to system(s) and method(s) for alerting one or more service providers based on analysis of real-time sensor data. The system is configured to receive real-time sensor data and historical sensor data captured by one or more agent devices. Further, the system is configured to determine an anomaly corresponding to a target agent device from the one or more agent devices, based on comparison of the real-time sensor data and one or more predefined threshold parameters. The system is further configured to generate an alert corresponding to the anomaly and identify one or more service providers, affected by the anomaly, based on analysis of the historical sensor data and the anomaly. Further, the system is configured to transmit the alert to the one or more service providers, thereby alerting the one or more service providers.

### CROSS-REFERENCE TO RELATED APPLICATIONS AND PRIORITY

The present application claims priority from Indian Patent Application No. 201611023628 filed on 11 Jul. 2016 the entirety of which is hereby incorporated by reference.

### TECHNICAL FIELD

The present disclosure in general relates to the field of sensor data analysis. More particularly, the present invention relates to performing sensor data analysis for alerting one or more service providers.

### BACKGROUND

Nowadays, Internet of Things (IoT) networks are widely used in order to monitor different environmental parameters such as temperature, humidity, air pressure, and the like. In some cases, the IoT monitoring systems may be used in smart homes in order to monitor security, safety and other environmental parameters. The IoT monitoring systems may receive real-time sensor data from an agent device, wherein the agent device is further connected to a set of IoT devices installed in a geographical location.

In the existing art, there are agent devices which are configured to monitor a particular type of environmental parameter. For example, an agent device may be configured to monitor a set of IoT devices for capturing gas leakage data. Another agent device may be configured to monitor a set of IoT device for detecting fire. Further, the data captured from the agent devices is monitored to determine any abnormal event and accordingly alerts are generated in order to alert users in the geographical area.

However, currently there is no system by which a data from multiple sources can be gathered and collectively analyzed in order to generate alerts.

### SUMMARY

This summary is provided to introduce aspects related to systems and methods for alerting one or more service providers based on analysis of sensor data and the aspects are further described below in the detailed description. This summary is not intended to identify essential features of the claimed subject matter nor is it intended for use in determining or limiting the scope of the claimed subject matter.

In one embodiment, a system for alerting one or more service providers based on analysis of real-time sensor data is illustrated. The system comprises a processor coupled to a memory, wherein the processor is to execute programmed instructions stored in the memory. The processor may be configured to execute a programmed instruction stored in the memory for receiving real-time sensor data and historical sensor data captured by one or more agent devices. In one embodiment, the one or more agent devices may correspond to one or more service provider of a set of service providers. In one embodiment, each agent device may be connected to a set of Internet of Things (IoT) devices configured to capture the real-time sensor data. In one embodiment, the historical sensor data may be received from a local database connected to the agent device. Further, the processor may be configured to execute a programmed instruction stored in the memory for determining an anomaly corresponding to a target agent device from the one or more agent devices, based on comparison of the real-time sensor data and one or more predefined threshold parameters. Further, the processor may be configured to execute a programmed instruction stored in the memory for generating an alert corresponding to the anomaly. Further, the processor may be configured to execute a programmed instruction stored in the memory for identifying one or more service providers, affected by the anomaly, based on analysis of the historical sensor data and the anomaly. Further, the processor may be configured to execute a programmed instruction stored in the memory for transmitting the alert to the one or more service providers, thereby alerting the one or more service providers.

In one embodiment, a method for alerting one or more service providers based on analysis of real-time sensor data is illustrated. The method may comprise receiving real-time sensor data and historical sensor data captured by one or more agent devices. In one embodiment, the one or more agent devices may correspond to one or more service provider of a set of service providers. In one embodiment, each agent device may be connected to a set of Internet of Things (IoT) devices configured to capture the real-time sensor data. In one embodiment, the historical sensor data may be received from a local database connected to the agent device. The method may further comprise determining an anomaly corresponding to a target agent device from the one or more agent devices, based on comparison of the real-time sensor data and one or more predefined threshold parameters. The method may further comprise generating an alert corresponding to the anomaly. The method may further comprise identifying one or more service providers, affected by the anomaly, based on analysis of the historical sensor data and the anomaly. The method may further comprise transmitting the alert to the one or more service providers, thereby alerting the one or more service providers.

In one embodiment, a non-transitory computer readable medium embodying a program executable in a computing device for alerting one or more service providers based on analysis of real-time sensor data is illustrated. The program comprises a program code for receiving real-time sensor data and historical sensor data captured by one or more agent devices. In one embodiment, the one or more agent devices may correspond to one or more service provider of a set of service providers. In one embodiment, each agent device may be connected to a set of Internet of Things (IoT) devices configured to capture the real-time sensor data. In one embodiment, the historical sensor data may be received from a local database connected to the agent device. The program comprises a program code for determining an anomaly corresponding to a target agent device from the one or more agent devices, based on comparison of the real-time sensor data and one or more predefined threshold parameters. The program comprises a program code for generating an alert corresponding to the anomaly. The program comprises a program code for identifying one or more service providers, affected by the anomaly, based on analysis of the historical sensor data and the anomaly. The program comprises a program code for transmitting the alert to the one or more service providers, thereby alerting the one or more service providers.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for alerting one or more service providers based on analysis of real-time sensor data, in accordance with an embodiment of the present subject matter.

FIG. 2 illustrates the system for alerting one or more service providers based on analysis of real-time sensor data, in accordance with an embodiment of the present subject matter.

FIG. 3 illustrates a flow diagram for alerting one or more service providers based on analysis of real-time sensor data, in accordance with an embodiment of the present subject matter.

### DETAILED DESCRIPTION

The present disclosure relates to a system and method to control and manage multiple sets of IoT devices and its associated agent devices. Each agent device and its service in the proposed system comprise a specific requirement, tasks and its associated control functions. Also each agent device in the system may be associated a set of IoT devices and user devices accessible by the system. The system may be configured to connect both user devices and IoT devices through multi-path communication channel In one embodiment, the system is configured to send instructions and receive real-time sensor data using the agent device via multiple interfaces simultaneously.

In one embodiment, the system may be implemented at centralized server, a cloud platform or a distributed network. The system is further configured to handle different network interfaces such as WLAN, LTE, LTE-A, other wired and wireless technologies, Bluetooth, ZigBee, BPL, and the like in order to gather data from the agent devices. In one embodiment, the system enables a software application layer to receive process, decide, control and transmit the different data sets to the IoT devices. Further, the system also facilitates end-users/enterprises to register/unregister their IoT devices and receive real time sensor data from the IoT devices through the Network. The Users of the system may be provisioned with administrative privileges to add, remove, control and manage the IoT devices associated with a particular agent device.

In one embodiment, each interested party or IoT devices can request to connect to the system via a secure, user account module of the system. Once accepted, the IoT device becomes a part of the system. In one embodiment, a set of IoT devices are configured to communicate with an agent device which is further registered with the system. The agent device acts as a sensor data collector for collecting sensor data from one or more sensors attached to each IoT device. The sensors may be pre-configured, built-in or custom-installed on the IoT Devices.

In one embodiment, the agent devices are configured to leveraging Multipath TCP communication established with the system via different network channels/interfaces on the agent device. Apart from facilitating data synchronization with the system, the agent device is also configured to notify system of any sudden changes or improper function of the IoT device. When such reports are received, the system may review the situation and take appropriate remedial/corrective actions based on pre-configured rules. Further, the system may also act as central body to communicate the information captured from one agent device with the other agent devices.

In one embodiment, a remote IoT control application may be implemented on each of the IoT devices. The remote IoT control application may be configured to works on IoT API to communicate with the system to send, receive and manage information between different IoT devices connected to the system. The system is configured to enable an Intelligent Internet of Things network for gathering real-time sensor data from different IoT devices and alerting one or more service providers based on analysis of real-time sensor data.

For this purpose, the system is configured to enable an artificial intelligent based Multi-agent Multi Interface module. The artificial intelligent based Multi-agent Multi Interface module is configured to establish multiple communication channels between the agent device and the system for effective and reliable communication with connected agent devices and the system. In one embodiment, the artificial intelligent based Multi-agent Multi Interface module may also be enabled over each of the agent devices for capturing sensor data from the IoT devices using multiple communication channels.

In one embodiment, each IoT device is configured to use a multiprocessor to enable multi channel communication between the agent device and the IoT devices. Further, the system is configured to acquire real-time sensor data through parallel communication channels enabled by the artificial intelligent based Multi-agent Multi Interface module. Further, the artificial intelligent based Multi-agent Multi Interface module is configured to enable faster, reliable and robust communication infrastructure between IoT devices or entities and system for advanced IoT infrastructure and services. In one embodiment, the set of IoT devices are configured to collect real-time sensor data and transmit the real-time sensor data to the system through the artificial intelligent based Multi-agent Multi Interface module enabled at the respective agent device.

In one embodiment, the system is enabled over a central server infrastructure and multiple network interfaces connected to the Internet. Further, each agent device connected to the system may have one or more network interfaces dedicated to it. The network interface IP addresses may be provided to a particular agent device and its associated set of IoT devices, end user groups and machines. Whenever information is received by a particular interface, the information may be processed by the specific agent device. Further, the agent devices connected to the system may be associated with at least one service provider, wherein the service provider may be selected from a set of natural gas service providers, a set of fire extinguisher service providers, a set of public safety service providers, a set of water service providers, a set of security service providers and the like.

In one embodiment, the system may be configured to receive real-time sensor data as well as historical sensor data captured by the one or more agent devices from the set of IoT devices connected to the agent device. In one embodiment, the real-time sensor data is received by the system through multiple communication channels. In one embodiment, the historical sensor data may be received from a local database associated with the agent device. Further, the system may be configured to determine an anomaly corresponding to a target agent device from the one or more agent devices, based on comparison of the real-time sensor data and one or more predefined threshold parameters. The comparison may be performed using an artificial intelligence network. The one or more predefined threshold parameters are set in order to detect outliers in the real-time sensor data. Further, the system may be configured to generate an alert corresponding to the anomaly. Further, the system may identify one or more service providers, affected by the anomaly, based on analysis of the historical sensor data and the anomaly. Further, the system may transmit the alert to the one or more service providers, thereby alerting the one or more service providers of the upcoming undesirable event.

While aspects of described system and method alerting one or more service providers based on analysis of real-time sensor data may be implemented in any number of different computing systems, environments, and/or configurations, the embodiments are described in the context of the following exemplary system.

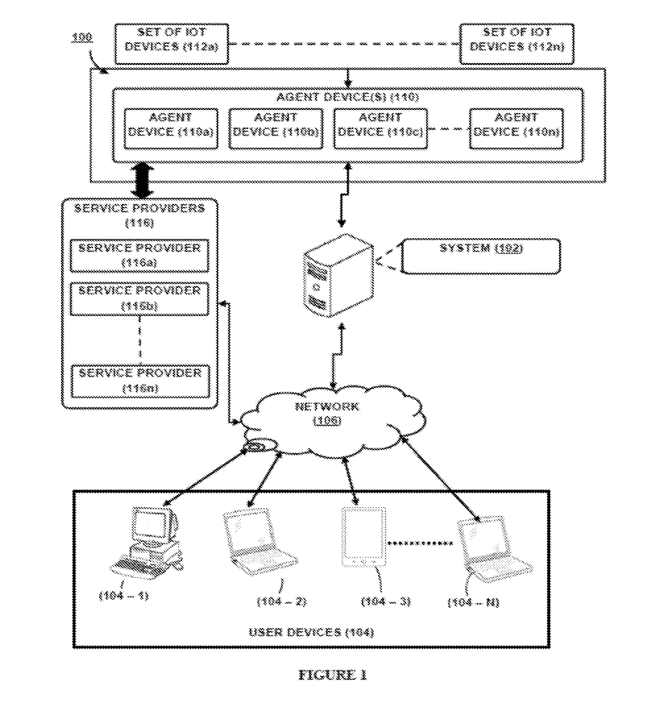

Referring now to FIG. 1, a network implementation 100 of a system 102 for alerting one or more service providers based on analysis of real-time sensor data is disclosed. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that the system 102 may be accessed by a primary user through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation, file server, version control servers, bugs tracking servers. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

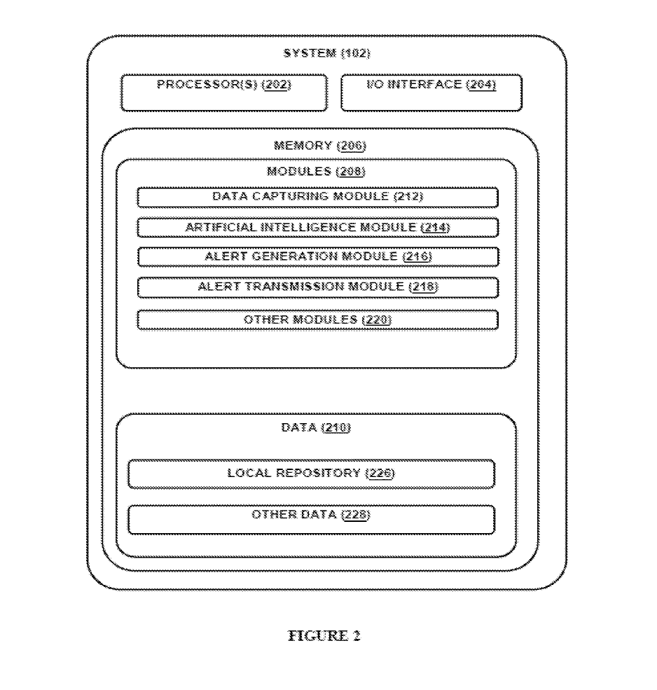

Further, the system 102 is configured to connect with one or more agent devices 110. In one embodiment, each agent device may correspond to a service provider of a set of service providers 116. In one embodiment, each agent device is configured monitor a set of IoT devices 112 and captures the real-time sensor data from the set of IoT devices. Once the real-time data and the historical sensor data is captured from the agent devices 110, the system 102 is configured to process this information and generate alerts for alerting one or more service providers corresponding to the one or more agent devices. The process of alerting one or more service providers based on analysis of real-time sensor data is further elaborated with respect to FIG. 2.

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the user devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks, functions or implement particular abstract data types. In one implementation, the modules 208 may include a data capturing module 212, an artificial intelligence module 214, an alert generation module 216, an alert transmission module 218, and other modules 220. The other modules 220 may include programs or coded instructions that supplement applications and functions of the system 102. The data 210, amongst other things, serves as a repository for storing data processed, received, and generated by one or more of the modules 208. The data 210 may also include a local repository 226, and other data 228. The local repository 226 is configured to store data received from the set of IoT devices.

In one embodiment, the data capturing module 212 may be configured for receiving real-time sensor data and historical sensor data captured by one or more agent devices 110. The sensor data may be captured by the set of Internet of Things (IoT) devices 112 configured for capturing the real-time sensor data from sensors installed at each IoT device. In one embodiment, the one or more agent devices 110 may correspond to one or more service provider of a set of service providers 116. In one embodiment, service providers 116 include a set of natural gas service providers, a set of fire extinguisher service providers, a set of public safety service providers, a set of water service providers, a set of security service providers, and the like. In one embodiment, the historical sensor data may also be received from a local database connected to the agent devices 110. The local repository 226 acts as a local storage for maintaining the historical sensor data.

In one embodiment, the artificial intelligence module 214 may be configured for determining an anomaly corresponding to a target agent device from the one or more agent devices, based on comparison of the real-time sensor data and one or more predefined threshold parameters. The anomaly may be an outlier indication some abnormal/undesirable event has taken place.

Further, the alert generation module 216 may be configured for generating an alert corresponding to the anomaly. For example, the alert generation module 216 may generate an alert in the form fire alarm. This fire alarm may be transmitted to the affected service providers.

In one embodiment, the artificial intelligence module 214 may be configured for identifying the one or more service providers, affected by the anomaly, based on analysis of the historical sensor data and the anomaly. In one embodiment, analysis of the historical sensor data and the anomaly to determine the one or more service providers is performed using at least one artificial intelligence based data analysis technique. The artificial intelligence based data analysis technique may be a machine learning technique configured to analyse different patterns and accordingly determine one or more service providers affected by the anomaly. For example, in case of fire alarm, the system 102 may send alert to fire extinguisher service provider as well as gas leak detection service in order to avoid further consequences of the fire spreading.

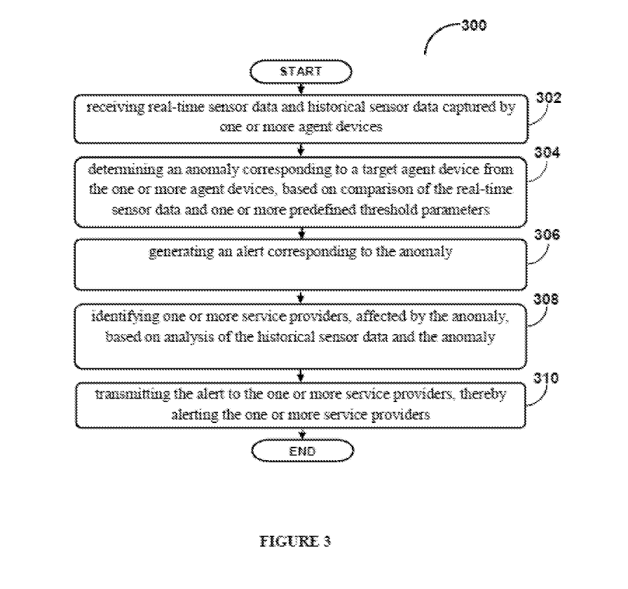

In one embodiment, the alert transmission module 218 may be configured for transmitting the alert to the one or more service providers, thereby alerting the one or more service providers. The method for alerting one or more service providers based on analysis of real-time sensor data is further illustrated with respect to the block diagram of FIG. 3.

Referring now to FIG. 3, a method 300 for alerting one or more service providers based on analysis of real-time sensor data is disclosed, in accordance with an embodiment of the present subject matter. The method 300 may be described in the general context of computer executable instructions. Generally, computer executable instructions can include routines, programs, objects, components, data structures, procedures, modules, functions, and the like, that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 may be considered to be implemented in the above described system 102.

At block 302, the data capturing module 212 may be configured for receiving real-time sensor data and historical sensor data captured by one or more agent devices 110. The sensor data may be captured by the set of Internet of Things (IoT) devices 112 configured for capturing the real-time sensor data from sensors installed at each IoT device. In one embodiment, the one or more agent devices 110 may correspond to one or more service provider of a set of service providers 116. In one embodiment, the set of service providers 116 include a set of natural gas service providers, a set of fire extinguisher service providers, a set of public safety service providers, a set of water service providers, a set of security service providers, and the like. In one embodiment, the historical sensor data may also be received from a local database connected to the agent devices 110. The local repository 226 acts as a local storage for maintaining the historical sensor data.

At block 304, the artificial intelligence module 214 may be configured for determining an anomaly corresponding to a target agent device from the one or more agent devices, based on comparison of the real-time sensor data and one or more predefined threshold parameters. The anomaly may be an outlier indication some abnormal/undesirable event has taken place. In one embodiment, the wherein the artificial intelligence module 214 may be configured to update the set of threshold parameters based on the sensor data captured from the IoT devices 112.

At block 306, the alert generation module 216 may be configured for generating an alert corresponding to the anomaly. For example, the alert generation module 216 may generate an alert in the form fire alarm. This fire alarm may be transmitted to the affected service providers.

At block 308, the artificial intelligence module 214 may be configured for identifying the one or more service providers, affected by the anomaly, based on analysis of the historical sensor data and the anomaly. In one embodiment, analysis of the historical sensor data and the anomaly to determine the one or more service providers is performed using at least one artificial intelligence based data analysis technique. The artificial intelligence based data analysis technique may be a machine learning technique configured to analyse different patterns and accordingly determine one or more service providers affected by the anomaly. For example, in case of fire alarm, the system 102 may send alert to fire extinguisher service provider as well as gas leak detection service in order to avoid further consequences of the fire spreading.

At block 310, the alert transmission module 218 may be configured for transmitting the alert to the one or more service providers, thereby alerting the one or more service providers.

In one example, a set of IoT device 112 may be connected to gas meters of a group of smart houses, and are configured to detect gas leakage data using one or more sensors installed on the each of the IoT devices. Further, the set of IoT devices 112 are connected to the system 102 through an agent device 110. The agent device 110 is configured to collect the real-time sensor data and transmit the real-time sensor data to the system 102 through multiple communication channels in distributed network architecture. Further, the system 102 is configured to generate alerts for one or more service providers including the natural gas supply service, based on the analysis of the real-time sensor data and the historical sensor data corresponding to the set of IoT devices. Further, system 102 is configured to alert the one or more service providers including the natural gas supply service to take necessary action. For example, apart from the natural gas supply service, the system may also alert a fire extinguisher service such that necessary preventive actions can be taken.

In one example, the set of IoT device may be configured to monitor water supply and control the building water motor based on the flow rate and water reserve. In this case, the system 102 is configured to detect shortage of water based on the real-time sensor data and generate alerts when the water level goes down. The water agent device 110 may calculates the time to empty and submits water filling request. In case of the connection between the system 102 and the water service agent is broken, the system 102 is configured to receive this information from other service agent devices and accordingly take necessary action.

In another example, a set of IoT sensors 112 may be configured to monitor natural disaster such as human trapped inside a building and needs emergency evacuation, communication with government departments, fire, hospitals, etc. the set of IoT devices 112 may connect with the respective agent device 110 through multipath communication channel and accordingly the agent device 110 may send this information to the system 102 for taking the necessary action. The system 102 may analyze this information and accordingly generate alerts and transmit the alerts to one or more service providers for taking necessary action.

Although implementations for methods and systems for alerting one or more service providers based on analysis of real-time sensor data has been described, it is to be understood that the appended claims are not necessarily limited to the specific features or methods described. Rather, the specific features and methods are disclosed as examples of implementations for alerting one or more service providers based on analysis of real-time sensor data.

We claim:

1. A method for alerting one or more service providers based on analysis of real-time sensor data, the method comprising steps of:
receiving, by a processor, real-time sensor data and historical sensor data captured by one or more agent devices, wherein the one or more agent devices corresponds to one or more service provider of a set of service providers;
determining, by the processor, an anomaly corresponding to a target agent device from the one or more agent devices, based on comparison of the real-time sensor data and one or more predefined threshold parameters;
generating, by the processor, an alert corresponding to the anomaly;
identifying, by the processor, one or more service providers, affected by the anomaly, based on analysis of the historical sensor data and the anomaly; and
transmitting, by the processor, the alert to the one or more service providers, thereby alerting the one or more service providers.

2. The method of claim 1, wherein the set of service providers include a set of natural gas service providers, a set of fire extinguisher service providers, a set of public safety service providers, a set of water service providers, and a set of security service providers.

3. The method of claim 1, wherein the analysis of the historical sensor data and the anomaly to determine the one or more service providers is performed using at least one artificial intelligence based data analysis technique.

4. The method of claim 1, wherein the artificial intelligence engine updates the set of threshold parameters based on the sensor data.

5. The method of claim 1, wherein the one or more agent devices capture the sensor data from a set of Internet of Thing (IoT) devices connected to each of the agent device, and wherein each set of IoT devices monitors one or more environmental parameters associated with a geographical area using one or more sensors on the IoT device, and wherein each agent device receives sensor data from the set of IoT device through a multipath communication channel.

6. A system for alerting one or more service providers based on analysis of real-time sensor data, the system comprising:
a memory; and
a processor coupled to the memory, wherein the processor is configured for:
receiving real-time sensor data and historical sensor data captured by one or more agent devices, wherein the one or more agent devices corresponds to one or more service provider of a set of service providers;
determining an anomaly corresponding to a target agent device from the one or more agent devices, based on comparison of the real-time sensor data and one or more predefined threshold parameters;
generating an alert corresponding to the anomaly;
identifying one or more service providers, affected by the anomaly, based on analysis of the historical sensor data and the anomaly; and
transmitting the alert to the one or more service providers, thereby alerting the one or more service providers.

7. The system of claim 6, wherein the set of service providers include a set of natural gas service providers, a set of fire extinguisher service providers, a set of public safety service providers, a set of water service providers, and a set of security service providers.

8. The system of claim 6, wherein the analysis of the historical sensor data and the anomaly to determine the one or more service providers is performed using at least one artificial intelligence based data analysis technique.

9. The system of claim 6, wherein the artificial intelligence engine updates the set of threshold parameters based on the sensor data.

10. The system of claim 6, wherein the one or more agent devices capture the sensor data from a set of Internet of Thing (IoT) devices connected to each of the agent device, and wherein each set of IoT devices monitors one or more environmental parameters associated with a geographical area using one or more sensors on the IoT device, and wherein each agent device receives sensor data from the set of IoT device through a multipath communication channel.

11. A non-transitory computer readable medium embodying a program executable in a computing device for alerting one or more service providers based on analysis of real-time sensor data, the computer program product comprising:
a program code for receiving real-time sensor data and historical sensor data captured by one or more agent devices, wherein the one or more agent devices corresponds to one or more service provider of a set of service providers;
a program code for determining an anomaly corresponding to a target agent device from the one or more agent devices, based on comparison of the real-time sensor data and one or more predefined threshold parameters;
a program code for generating an alert corresponding to the anomaly;
a program code for identifying one or more service providers, affected by the anomaly, based on analysis of the historical sensor data and the anomaly; and
a program code for transmitting the alert to the one or more service providers, thereby alerting the one or more service providers.
